(19) United States
(12) Patent Application Publication
(10) Pub. No.: US 2004/0200079 A1
(43) Pub. Date: Oct. 14, 2004

(54) Tool with ergonomic soft-grip handle

(76) Inventors: Cheryl Ann Stoughton, Denver, CO (US); Kurt Van Ulmer, Denver, CO (US); Michael D. Hennessey, Denver, CO (US)

Correspondence Address: TIMOTHY J MARTIN, PC, 9250 W 5TH AVENUE, SUITE 200, LAKEWOOD, CO, 80226, US

(21) Appl. No.: 10/410,889

(22) Filed: Apr. 9, 2003

(51) Int. Cl. B27B 21/00

(52) U.S. Cl. 30/514

(57) ABSTRACT

A tool has a tool element extending longitudinally of a handle. The handle has a body portion, a neck portion and a head portion with a forward base. The neck portion has a smaller cross-sectional dimension than the forward base. The body portion is generally oval in cross-section. The body portion has a major transverse axis dimension that decreases from a proximal end that is adjacent to the neck toward a distal tip and a minor transverse axis dimension that is less than the major transverse axis dimension. A skin of cushion material may be disposed over a major part of the body portion.

### FIELD OF THE INVENTION

The present invention is broadly directed to hand held tools. More particularly, the present invention is directed to tools having ergonomic handles. The present invention is specifically directed to tools used in carving pumpkins, watermelons or other vegetables as artistic objects.

### BACKGROUND OF THE INVENTION

A wide variety of cutting and shaping tools have been known since early times. While many cutting tools used today are mechanically driven, there is still a wide variety of manually employed cutting implements which may be used to perform a specific function. For example, knives, awls, saws, scissors, chisels and the like are all examples of cutting tools found in everyday use which are of the type that are manually implemented. Not only is there a plethora of distinctive types of cutting tools, but many varieties exist within each type such that a specialized function may be performed by a respective tool.

A variety of specialized cutting tools have been developed by or for the assignee of the present invention. These tools are ones particularly adapted for cutting or carving features into relatively soft materials such as pumpkins, squashes, melons, etc. In such use, a decorative design is placed upon the fleshy shell of a pumpkin, for example, and the design features are then carved in the shell of the pumpkin, primarily by small, hand held saws and by drilling tools.

It may be readily appreciated, the activity of pumpkin carving or the creation of designs in other vegetable materials provides a wholesome family function. Prior to the development efforts of the assignee of this invention, pumpkin carving was typically accomplished with the use of pocketknives, paring knives and the like. Due to the size of these cutting instruments, a typical carver was only to create limited, fairly large scale decorative features. In addition, such knives were quite difficult to control and this, in conjunction with the sharpness of the knife, exposed the carver to the danger of injury. The result was that pumpkin carving had a fairly high degree of danger for children as well as adults.

In an effort to meet the needs for safer instruments that might be utilized to carve decorative designs in pumpkin shells, a pumpkin carving kit was developed and is disclosed in U.S. Pat. No. 4,828,114 issued May 9, 1989 to John P. Bardeen. This pumpkin carving kit allowed more intricate designs to be carved in the pumpkin shell and increased the safety of the normal, pre-existing carving techniques. The pumpkin carving kit and implements disclosed in this patent were a substantial improvement over the pre-existing tools used to carve pumpkins.

A hand held cutting tool, such as employed in the above-described kit, was disclosed in U.S. Pat. No. 4,841,638 issued Jun. 27, 1989 to John P. Bardeen et al. In this patent, a cutting element in the form of a saw or drill was held between two handle sections that were mateable to create a handle having an elongated shank that was a regular polygon in cross-section. The shank then terminated at a forward transverse disk from which the tool element projected. The two-part construction of such a handle was modified to create a handle of similar shape part of a single, integral one-piece molding to eliminate the assembled handle sections. Such a handle is shown, for example, in U.S. Pat. No. 5,832,615 issues Nov. 10, 1998 to Costen et al.

More recently, an improved handle was developed to hold a safety saw especially suited for young children. This tool and handle is disclosed in U.S. Pat. No. 6,497,046 issued Dec. 24, 2002 to Bardeen et al. In this patent, the tool handle had a first portion, a second portion and a wasted portion therebetween. The minimum diameter of the wasted portion was no more than 50 percent of the maximum diameter of the second portion with the first and second portions disclosed to have equal radii. This handle was particularly suited to be grasped by the hand of a small child.

A wide variety of handle constructions and designs have been developed in the past to hold cutting instruments. Despite these developments, there remains a need for improved tools having more ergonomic handles. There is a special need for ergonomic handles supporting tool elements which can be used for intricate carving of vegetable materials. The present invention is directed to meeting these needs.

### SUMMARY OF THE INVENTION

It is an object of the present invention to provide a new and useful tool having an ergonomic handle.

Another object of the present invention is to provide a tool with a handle particularly adapted for intricate carving and shaping of a vegetable material.

Still a further object of the present invention is to provide a tool element supported by a handle wherein the handle may readily be grasped and used by the human hand.

To accomplish these objects, the present invention is directed to a tool that includes a handle having a central longitudinal axis and a tool element extending longitudinally forwardly of the handle and supported thereby. In it broad form, the handle includes a head portion having a forward base with a first cross-sectional dimension from which the tool element extends, a next portion that is smaller in cross-sectional dimension than the base and a body portion having a proximal end adjacent to the neck portion and a distal tip opposite the proximal end. The body portion is generally oval in cross-section with a major and a minor transverse axis. The major transverse axis dimension decreases in a longitudinal direction from the proximal end towards the distal tip, and the minor transverse axis dimension is less in dimension than the major transverse axis over a majority of the body portion.

In one embodiment, the tool of the present invention includes a body portion wherein the minor transverse axis dimension is generally constant over a majority of the body portion. Here, also, the head portion may be fustoconical in shape and the neck portion circular in cross-section. Shoulder portions may join the body portion and the neck portion with these shoulder portions being located, for example, on opposite sides of the handle. The shoulder portions may be formed by arcuate surfaces that diverge outwardly from one another in a direction from the neck portion to terminate proximately to opposite ends of the major axis of the body portion.

In one embodiment, the body portion has a longitudinally extending slot extending transversely therethrough. This slot may extend in the direction of the minor transverse axis. In another embodiment, the body portion has at least one longitudinally rib projecting outwardly therefrom. In this embodiment, a pair of longitudinally extending ribs are disclosed with the ribs projecting oppositely one another on opposite sides of the body portion. The ribs may project along the minor transverse axis.

In some of the exemplary embodiments, a skin of cushion material is disposed over a major part of the body portion. To this end, the handle is formed as a handle core with the skin overmolded thereon. This skin may extend over some of the neck portion, and it may also form a collar around the neck portion. The skin may also, if desired, extend along the shoulder portions where such shoulder portions are formed in the handle. Where the body portion has longitudinal ribs, the ribs may project the skin so as to have exposed top rib surfaces. In the embodiments described in this invention, the handle is formed as an integral one piece molding of plastic. The skin is formed as an overmold of a soft grip material. Bores can be used to increase the mechanical lock of the skin to the handle core. The tool elements secured to the handle may be selected from a group consisting of saw blades, scrapers, sculpting members and poking prongs.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a perspective view of a tool showing the handle according to a first exemplary embodiment of the present invention supporting a tool element in the form of a saw blade;

FIG. 2 is a side view in elevation of the tool shown in FIG. 1;

FIG. 3 is a top plan view of the tool shown in FIGS. 1 and 2;

FIG. 4 is a cross-sectional view taken about lines 4-4 of FIG. 2;

FIG. 5 is a perspective view of the handle core used with the tool shown in FIGS. 1-4;

FIG. 6 is a top plan view of the handle core of FIG. 5;

FIG. 7 is a side view in elevation of the handle core of FIGS. 5 and 6;

FIG. 8 is a cross-sectional view taken about lines 8-8 of FIG. 7;

FIG. 9 is a cross-sectional view taken about lines 9-9 of FIG. 7;

FIG. 10 is a side view in elevation of a second exemplary embodiment of a tool-supporting element in the form of a safety saw blade;

FIG. 11 is a top plan view of the tool shown in FIG. 10;

FIG. 12 is a cross-section view taken about lines 12-12 of FIG. 10;

FIG. 13 is a side view in elevation showing a third exemplary embodiment of the tool according to the present invention;

FIG. 14 is a top plan view of the tool shown in FIG. 13;

FIG. 15 is a side view in elevation showing a fourth exemplary embodiment of a tool according to the present invention supporting a tool element in the form of a poking prong; and

FIG. 16 is a top plan view of a fifth exemplary embodiment of the tool according to the present invention showing a tool element in the form of a sculpting member.

### DETAILED DESCRIPTION OF THE EXEMPLARY EMBODIMENTS

The present invention is broadly directed to tools which may be hand held and operated. The present invention is particularly directed to an ergonomic, hand held tool that is especially configured for grasping of the human hand while carving intricate designs in vegetables, such as pumpkins, watermelons, squashes and the like. The invention particularly concerns an improved ergonomic handle for such a tool which handle may support a tool element selected, for example, from a group consisting of saw blades, sculpting members and poking prongs.

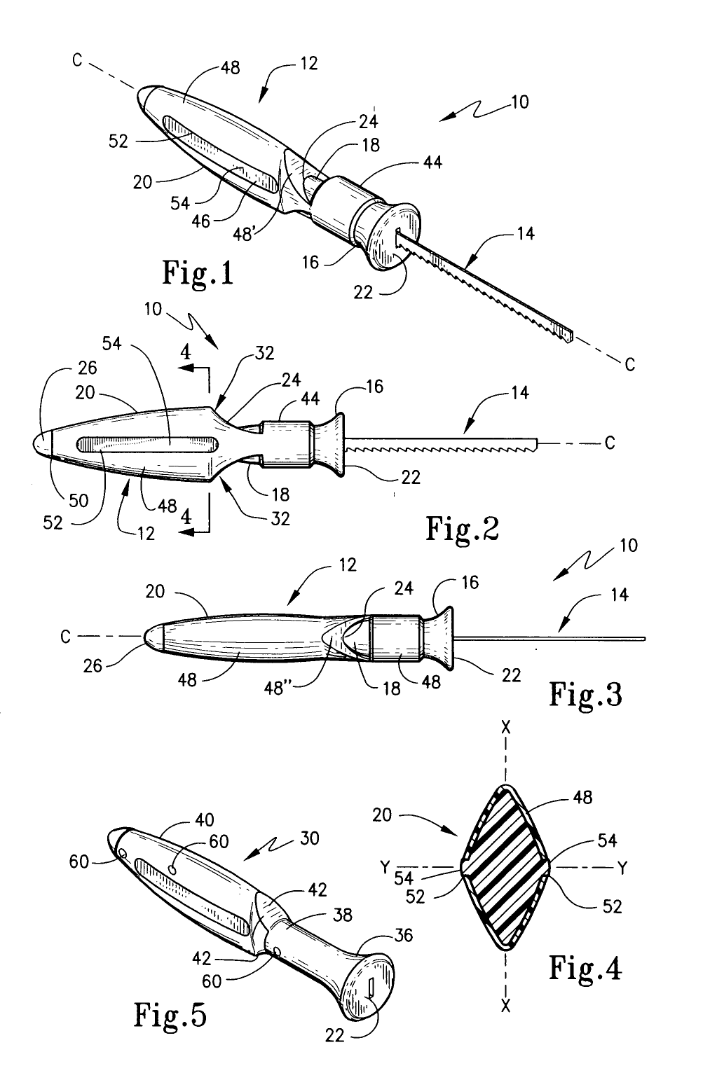

A first exemplary embodiment of the present invention is introduced in FIGS. 1-4. In these figures, tool 10 is shown to include a handle 12 and a tool element in the form of a saw blade 14 extending forwardly of the handle and supported thereby. As is shown in these figures, handle 12 and saw blade 14 extend along a central longitudinal axis “C”. As is also illustrated in these figures, handle 12 includes a head portion 16 a neck portion 18 and a body portion 20. Head portion 16 has a forward base 22 with a first cross-sectional dimension. Base 22 is preferably formed in a flat plane that is transverse to central axis “C”. To be transverse, of course, it is meant that surface 22 may be oblique to or perpendicular to axis “C”; in this exemplary embodiment, forward base 22 is formed generally perpendicularly to central axis “C”.

Neck portion 18 is shown to be of smaller cross-sectional dimension than base 22. Body portion 20 has a proximal end 24 that is adjacent to neck portion 18 and a distal end 26 that is located oppositely of proximal end 24. Body portion 20 may be joined to neck portion 18 by arcuate shoulder portions 32. As is shown in FIG. 4, body portion 20 is generally oval in cross-section and has a major transverse axis “X” and a minor transverse axis “Y” that is smaller in dimension than the major transverse axis “X”.

The construction and features of handle 12 can be more fully appreciated with reference to FIGS. 5-9. These figures illustrate the handle core 30 that is used to construct tool 10 shown in the first exemplary embodiment of FIGS. 1-4. With reference to FIGS. 5-9, it may be seen that handle core 30 is an integral piece of molded material, such as a suitable plastic. Handle core 30 includes head portion 36, neck portion 38 and body portion 40 that correspond, respectively, to head portion 16, neck portion 18 and body portion 20 of handle 12. Body portion 40 is joined to neck portion 38 by means of a pair of shoulder portions 42 which are formed by arcuate surfaces that diverge outwardly from one another in the direction from the neck portion 38 to terminate at body portion forward 40 proximately to opposite ends of the major axis “X” of body portion 40 at proximal end 24. These shoulder portions 42 define the should portions 32 of handle 12. Head portion 36 and, correspondingly, head portion 16 of handle 12, formed by head portion 36 of core 30, is frustoconical in shape. Neck portion 38, which corresponds to neck portion 16 of handle 12, is circular in cross-section.

Body portion 40 of handle core 30 is provided with at least one, but preferably two longitudinal extending ribs 46 that extend along side body portion 40 for a majority of its longitudinal length. Ribs 46 project oppositely one another on opposite sides of body portion 40 and, as illustrated, project along the minor transverse axis “Y”. With reference to FIGS. 8 and 9, it may be seen that the major transverse axis dimension of handle core 30 and thus handle 12, that decreases in a longitudinal direction from the proximal end 24 to the distal tip 26. The minor transverse axis dimension is less than the major transverse dimension over a majority of the body portion. Accordingly, as is shown in FIGS. 8 and 9, the major transverse dimension, “x₁”, at the proximal end 24 is larger than the major axis dimension, “x₂”, proximate to distal tip 26. Minor transverse axis dimensions “y₁” and “y₂” are generally constant over a majority of the body portion, but are smaller than the major transverse axis dimension over a majority of the length of the handle portion.

With reference again to FIGS. 1-4, it may be seen that handle 12 includes a thin skin of a cushion material disposed over a major part of its body portion 12. That is, handle core 30 has a thin skin 48 of this cushioning material which may, for example, be a layer of approximately 1 millimeter thick formed of a soft grip material such as Technor Apex TPE 749126-P-1 Shore A 65-71 ASTM-2240.

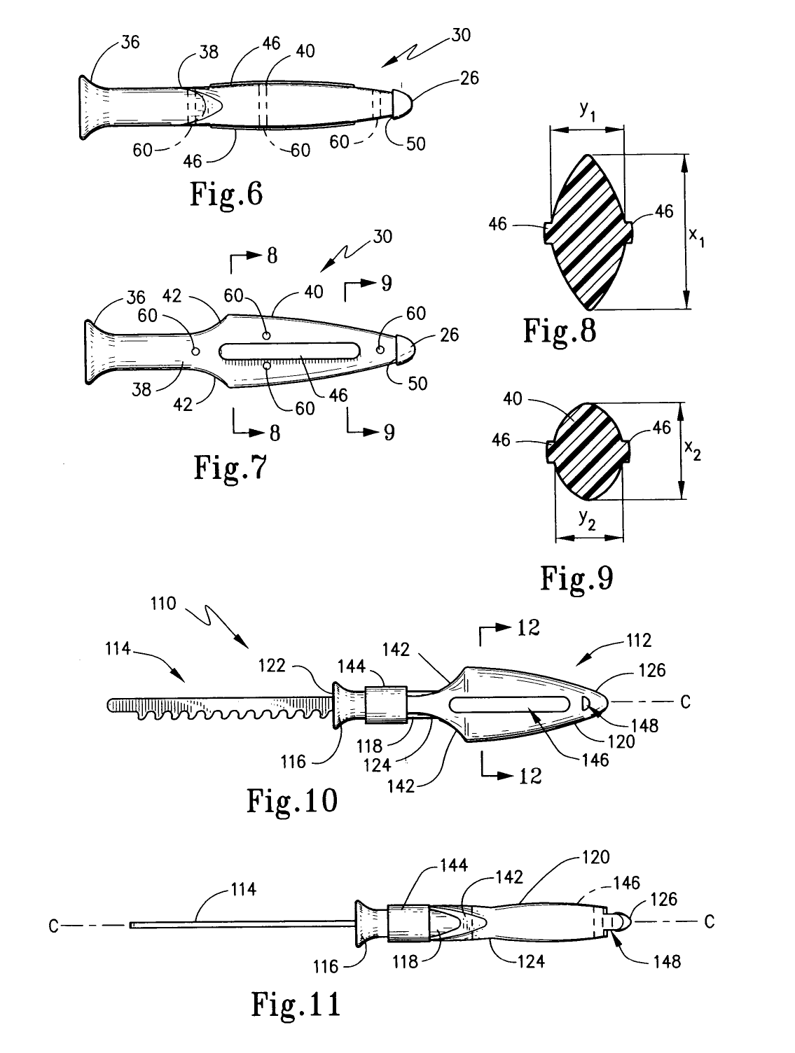

With reference to FIGS. 6 and 7, it may further be seen that distal tip 26 is a dome shaped nose and includes a rim 50 that projects outwardly from the surface of body portion 40 for approximately the intended thickness of skin 48. Likewise, ribs 46 project outwardly of the surface of body portion 40 for approximately the expected thickness of skin 48. Thus, when skin 48 is applied, as is shown in FIGS. 1-4, rim 50 provides a longitudinal limit for skin 48 with skin 48 having openings 52 to which ribs 46 project to have top rib surfaces 54 exposed. Moreover, with reference to these figures, it may be seen that skin 48 extends over some of neck portion 38 to form a collar 44. Skin 48 also extends along shoulder portions 42, as indicated at 48′. Preferably, skin 48 is formed as an overmold on handle core 30. Handle core 30 is also provided with a plurality of bores 60 extending therethrough. The material forming skin 48 fills these bores 60 to enhance the mechanical lock of skin 48 to core 30.

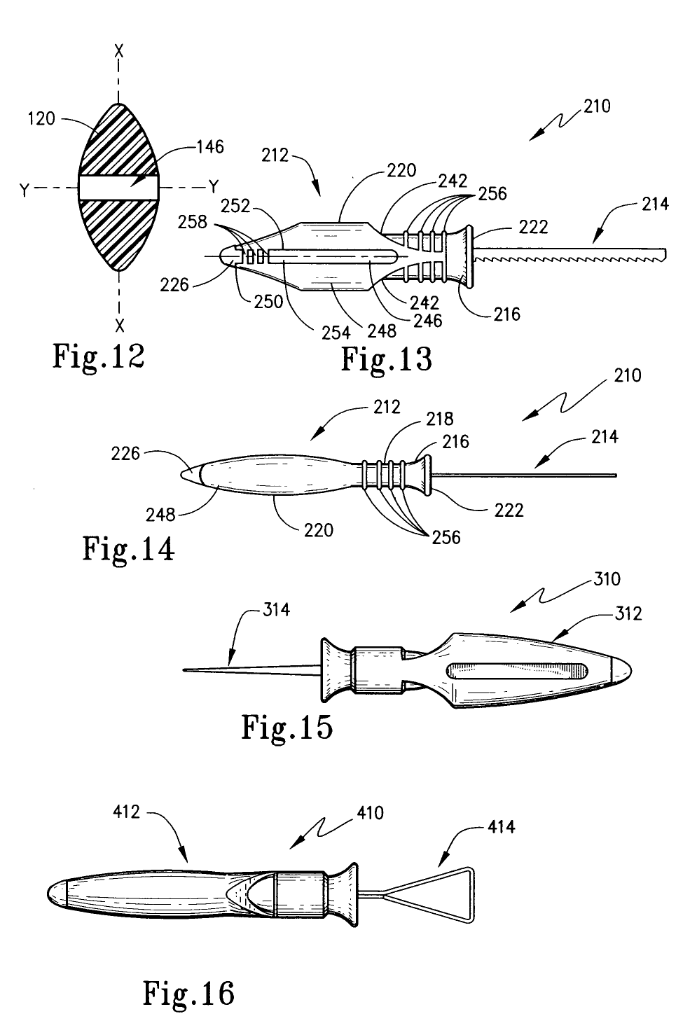

A second exemplary embodiment of the present invention is shown in FIGS. 10-12. In this embodiment, no overmold skin is employed. Rather, as is depicted in FIGS. 10-12, tool 110 includes a handle 112 and a tool element in the form of a safety saw blade 114. Handle 112 includes a head portion 116 that is again fustoconical in shape and is joined to a body portion 120 by means of a neck portion 118. Head portion 116 is again fustoconical in shape and includes a forward base 122 from which safety saw 114 extends along a central longitudinal axis “C”. Neck portion 118 is again cylindrical in cross-section and has an enlarged collar 144 formed integrally therewith.

Body portion 120 has a proximal end connected to neck portion 118 by a pair of shoulder portions 142 that are again arcuate in shape and diverge from one another from proximal end 124 in a direction toward distal tip 126. Further, as is illustrated in FIGS. 10-12, handle portion 120 has a longitudinally extending slot 146 that extends transversely completely through body portion 120 along minor axis “Y”. A half circular opening 148 also extends transversely along minor axis “Y” and is located between slot 146 and distal tip 126.

Body portion 120 is again generally oval in cross-section with a major axis dimension along major axis “X” that decreases in dimension in a longitudinal direction from the proximal end toward the distal tip. Handle portion 120 likewise has a minor axis dimension along minor axis “Y” that is less than the major axis dimension. As is shown in FIG. 11, however, the minor axis dimension first slightly increases and then slightly decreases in magnitude from the proximal end portion 124 to distal tip 126, but for all practical purposes may be referred to as substantially constant over a majority of the length of the body portion.

With reference now to FIGS. 13 and 14, a third exemplary embodiment of the present invention is illustrated. This embodiment is substantially similar to the embodiment shown in FIGS. 1-9. In FIGS. 13 and 14, tool 210 includes a handle 212 and a tool element in the form of a saw blade 214. Handle 212 again includes a core which is overmolded with a skin 248.

More particularly, handle 212 includes a head portion 216 that is formed as a frustum having an oval base. A neck portion 218 is smaller in dimension than the forward base 222 of head portion 216, and neck portion 218 interconnects head portion 216 to body portion 220. A pair of oppositely projecting shoulder portions 242 that are similar to shoulder portions 42 described above extend along the junction of body portion 220 and neck portion 218. Distal end 226 of body portion 220 again includes a rim 250, and a pair of ribs, such a rib 246, extend longitudinally of body portion 220 and project radially on opposite sides thereof along the minor axis.

In this embodiment, overmold skin 248, formed of a soft cushion material, is disposed over a majority of body portion 220 and includes a forward circumferential bands 256 molded into suitable circumferential grooves formed in the core of handle portion 212. To this end, collar 44 is eliminated from this embodiment. Further, ribs 246 project through openings 252 in skin 248 so that the surface of skin 248 is flush with the top surface 254 of each rib, such as rib 246. Small channels may be provided in the handle core so that skin 248 may include rearward bands 258, which, along with ribs 246 and forward bands 256 serve to mechanically lock skin 248 onto the core of handle 212.

Fourth and fifth exemplary embodiments of the present invention are shown, respectively, in FIGS. 15 and 16. In each of these embodiments, tools 310 and 410 are respectively shown to have handles 312 and 412 that are identical to handle 12, described above. FIGS. 15 and 16 are provided to illustrate that the tool element may take forms other than saw blades. Thus, for example, in FIG. 15, handle 312 supports a tool element in the form of a poking prong 314 used to puncture holes, for example, in a vegetable shell. FIG. 16 illustrates a tool 410 wherein handle 412 supports a sculpting member 414 in the form of a metal loop which may be used, for example, to shave the skin of a pumpkin away from the shell so as to create a sculpted design image, as is known in the art. Accordingly, it should be appreciated that the tool elements that are supported by the handle of the present invention may take any variety of forms as in known by the ordinarily skilled artisan in this field, but may particularly be selected from a group consisting of saw blades, sculpting members and poking prongs.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

We claim:

1. A tool comprising:
(A) a handle having a central longitudinal axis; and
(B) a tool element extending longitudinally forwardly of said handle and supported thereby and wherein said handle includes
(1) a head portion having a forward base with a first cross-sectional dimension and from which said tool element extends;
(2) a neck portion being of smaller cross-sectional dimension than said base; and
(3) a body portion having a proximal end adjacent to said neck portion and a distal tip opposite said proximal end, said body portion being generally oval in cross-section with a major transverse axis dimension that decreases in a longitudinal direction from the proximal end toward the distal tip and with a minor transverse axis dimension that is less than the major transverse axis dimension over a majority of said body portion.

2. A tool according to claim 1 wherein the minor transverse axis is generally constant in dimension over a majority of said body portion.

3. A tool according to claim 1 wherein said head portion is frustoconical in shape.

4. A tool according to claim 1 wherein said neck portion is circular in cross-section.

5. A tool according to claim 1 wherein said body portion and said neck portion are joined together by a pair of shoulder portions.

6. A tool according to claim 5 wherein said shoulder portions are located on opposite sides of said handle.

7. A tool according to claim 6 wherein said shoulders are formed by arcuate surfaces that diverge outwardly from one another in a direction from said neck portion to terminate proximately to opposite ends of the major axis of said body portion.

8. A tool according to claim 1 wherein said body portion has a longitudinally extending slot extending transversely therethrough.

9. A tool according to claim 8 wherein the slot extends in the direction of the minor transverse axis.

10. A tool according to claim 1 wherein said body portion has at least one longitudinally extending rib projecting outwardly therefrom.

11. A tool according to claim 10 including a pair of longitudinally extending ribs projecting oppositely one another on opposite sides of said body portion.

12. A tool according to claim 11 wherein said ribs project along the minor transverse axis.

13. A tool according to claim 1 wherein said handle includes a skin of cushion material disposed over a major part of said body portion.

14. A tool according to claim 13 wherein said skin extends over some of said neck portion.

15. A tool according to claim 14 wherein said skin forms a collar around said neck portion.

16. A tool according to claim 13 wherein said handle body portion has at least one bore extending therethrough, said skin filling the bore.

17. A tool according to claim 1 wherein said tool element in selected from a group consisting of saw blades, sculpting members and poking prongs

18. A tool comprising:
(A) a handle having a central longitudinal axis;
(B) a tool element extending longitudinally forwardly of said handle and supported thereby and wherein said handle has a core that includes
(1) a head portion having a forward base with a first cross-sectional dimension and from which said tool element extends;
(2) a neck portion being of smaller cross-sectional dimension than said base;
(3) a body portion having a proximal end adjacent to said neck portion and a distal tip opposite said proximal end, said body portion being generally oval in cross-section with major and minor axes and a major transverse axis dimension that decreases in a longitudinal direction from the proximal end toward the distal tip and with a minor transverse axis dimension that is less than the major transverse axis dimension over a majority of said body portion;
(4) a pair of shoulder portions joining said body portion and said neck portion; and
(C) a skin of cushion material disposed over a major part of said body portion.

19. A tool according to claim 18 wherein the minor transverse axis dimension is generally constant in dimension over a majority of said body portion.

20. A tool according to claim 19 wherein said skin extends over some of said shoulder portions and over some of said neck portion to define a collar around said neck portion.

21. A tool according to claim 18 wherein said shoulders are located on opposite sides of said handle and are formed by arcuate surfaces that diverge outwardly from one another in a direction from said neck portion to terminate proximately to opposite ends of the major axis of said body portion.

22. A tool according to claim 18 wherein said body portion has a pair of longitudinally extending ribs projecting oppositely one another on opposite sides of said body portion.

23. A tool according to claim 22 wherein said ribs project through said skin so as to have exposed top rib surfaces.

24. A tool according to claim 22 wherein said ribs project along the minor transverse axis.

25. A tool according to claim 22 wherein said body portion has at least one bore extending therethrough.

26. A tool according to claim 18 wherein said handle is formed as an integral one-piece molding of plastic and wherein said skin is formed as an overmold of soft grip material.

27. A tool according to claim 18 wherein said tool element in selected from a group consisting of saw blades, sculpting members and poking prongs.

28. A tool according to claim 18 wherein said skin extends over some of said shoulder portions and some of said neck portion.
